(19) United States
(12) Patent Application Publication
(10) Pub. No.: US 2014/0312268 A1
(43) Pub. Date: Oct. 23, 2014

(54) BATTERY BINDER

(71) Applicant: E I DU PONT DE NEMOURS AND COMPANY, Wilmington, DE (US)

(72) Inventor: Chongsoo Lim, Hockessin, DE (US)

(73) Assignee: E I DU PONT DE NEMOURS AND COMPANY, Wilmington, DE (US)

(21) Appl. No.: 14/260,097

(22) Filed: Apr. 23, 2014

Related U.S. Application Data
(60) Provisional application No. 61/815,175, filed on Apr. 23, 2013.

(51) Int. Cl. H01M 4/62; H01M 4/505; H01M 4/525

(52) U.S. Cl. CPC H01M 4/622; H01M 4/525; H01M 4/505; H01M 2220/30
USPC 252/182.1; 524/562; 524/561; 524/548

(57) ABSTRACT

Disclosed is a composition comprising an ethylene elastomer and a solvent wherein the composition is a binder for a lithium ion battery; the elastomer comprises or is produced from repeat units derived from ethylene and one or more comonomer selected from the group consisting of an alky(meth)acrylate; and the elastomer comprises a curing agent. The elastomer can further comprise or can be further produced from repeat units derived from a second alky (meth)acrylate, 2-butene-1,4-dioic acid or its derivative, or both.

This application claims priority to U.S. provisional application No. 61/815,175, filed Apr. 23, 2013; the entire disclosure of which is incorporated herein by reference.

The invention relates to binder and its use in a secondary battery, such as lithium ion battery.

### BACKGROUND OF THE INVENTION

Since commercial lithium ion batteries were first developed by Sony early 1990s, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as greener alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), a separator, and an electrolyte, which work in harmony to interconvert chemical energy into electrical energy reversibly as current flow reverses during charge and discharge process. Typically electrodes are constructed by applying active material onto current collector in the presence of binder that affords cohesion between active materials and their adhesion to current collector. The binder is commonly combined with carbon black for electric conductivity. Common active material for anodes is carbon (graphite) or silicon, and, for cathode, lithium metal oxides, mixed metal oxides, or metal salts of usually lithium. Current collector for anode is typically Cu, and Al is for cathode. The electrolyte can be a mixture of organic carbonates containing lithium salts. The organic carbonates can include ethylene carbonate, ethyl methyl carbonate, diethyl carbonate, or combinations thereof. The lithium salts can include LiPF₆, LiAsF₆, LiClO₄, LiCF₃SO₃, LiN(SO₂CF₃)₂ or combinations thereof. The separator is commonly made from stretched and thus micro-porous multi-layered film of polyethylene, polypropylene or combinations thereof.

Widely used binders comprise homopolymers and copolymers of polyvinylidene fluoride (PVDF), which have gained success as binders for cathodes and anodes in lithium ion battery technology. PVDF and copolymers such as p(VDF-HFP) (copolymer of vinylidene fluoride and hexafluoropropylene) are also utilized as polymer electrolytes and separators by itself or in combination with other materials. PVDF might have suitable properties for lithium ion battery application such as relatively wide redox window for electrochemical stability, high molecular weight for strong adhesion to current collector and robust cohesion between active materials, high polarity to increase compatibility with polar cathode active material and proper viscosity, and commercial availability in high purity. However, it is sometimes reported that PVDF needs improvement in adhesion, percent active loading, swelling behavior and flexibility. N-methyl-2-pyrrolidone (NMP), a typical solvent for PVDF, might need to be deselected at a certain point due to its toxicity associated issues. As the recent trends in portable electronics become slimmer and more flexible, the drawbacks of PVDF can be magnified depending on specific applications.

Polyolefinic materials with electron withdrawing substituents such as poly(methyl methacrylate)(PMMA), polyacrylic acids, polyacrylronitrile (PAN) and polyvinyl chloride (PVC) have been adopted in lithium ion battery technology. However, it would be a great contribution to the art if other polymers can be used in a battery binder system. Functionalized elastomeric ethylene copolymers with similar structures of above examples also have performance qualities that can be utilized as a binder material for lithium ion battery such as robust adhesion to the current collector, stronger binding, suitable swelling in electrolytes, higher active material loading, excellent flexibility and a comparable operating (redox/thermal) window. An ethylene elastomer such as VAMAC® currently produced and marketed by E. I. du Pont de Nemours and Company, Delaware, USA (DuPont) was then discovered as a suitable polymer for used in the binder. Such ethylene elastomer-based binder systems can be designed to crosslink during the cathode manufacturing process. Additionally, an ethylene elastomer can use non-NMP-based solvents for cost saving, facilitate dry/cure processing, and minimize hazard issues.

### SUMMARY OF THE INVENTION

A composition comprises an ethylene elastomer such as acrylic elastomer, and a solvent wherein the composition can be used as LIB cathode binder; the ethylene elastomer comprises repeat units derived from ethylene and a comonomer; the solvent can be one that is known to one skilled in the art or an ether or ester; and the comonomer can be an ∝, β-unsaturated monocarboxylic acid, an ∝, β-unsaturated dicarboxylic acid or its derivative, a vinyl ester, 2-butene-1,4-dioic acid or its derivative, or combinations of two or more thereof.

An electrode comprises a lithium compound such as, for example, lithium metal oxide, lithium mixed metal oxide, lithium metal salt, lithium metal phosphate or combinations of two or more thereof and a binder composition wherein the binder composition can be as disclosed above.

### BRIEF DESCRIPTION OF DRAWINGS

FIG. 1 is a plot of discharge of a coin cell against number of charge and discharge cycle.

FIG. 2 represents Coulombic efficiency of the coin cell shown in FIG. 1.

### DETAILED DESCRIPTION OF THE INVENTION

A comonomer disclosed herein does not comprise a comonomer having (1) an alkyl group containing more than four carbon atoms, (2) a nitrogen-containing comonomer, (3) an aromatic comonomer, (4) a conjugated diene, or (5) combinations of two or more of (1), (2), (3) and (4). The description following the verb “is” can be a definition.

An ∝, β-unsaturated monocarboxylic acid or its derivative can include an (meth)acrylic acid including acrylic acid, methacrylic acid, alkyl methacrylate, alkyl acrylate, or combinations of two or more thereof. Similarly, alkyl (meth)acrylate can include alkyl acrylate or alkyl methacrylate such as methacrylate, methyl acrylate, methyl methacrylate, ethyl acrylate, butyl acrylate, or combinations of two or more thereof.

An ∝, β-unsaturated dicarboxylic acid or its derivative can include maleic acid, fumaric acid, itaconic acid, a C₁-C₄ alkyl monoester of maleic acid, a C₁-C₄ alkyl monoester of fumaric acid, a C₁-C₄ alkyl monoester of itaconic acid, acid anhydride such as maleic anhydride and itaconic anhydride, or combinations of two or more thereof.

An example of vinyl ester can be vinyl acetate.

An example of 2-butene-1,4-dioic acid derivative an anhydride of the acid, monoalkyl ester of the acid, dialkyl ester of the acid, or combinations of two or more thereof.

Examples of the composition can be a dipolymer, a terpolymer, a tetrapolymer, or combinations of two or more thereof.

A dipolymer can comprise or be produced from ethylene and about 40 to about 80 weight %, 45 to about 75 weight %, or 50 to 70 weight % of a (meth)acrylate or alkyl (meth)acrylate such as methyl acrylate. The alkyl can have 1 to 8, preferably to 4, carbons in the alkyl group. The dipolymer can have a number average molecular weight (Mₙ) above 20,000, above 30,000, above 40,000, or above 55,000 with an upper limit of about 100,000 or about 150,000; and melt index from 2 to 20, or from 2 to 12 g/10 min; and preferably a polydispersity from about 2 to about 10.

A terpolymer can comprise or be produced from ethylene, an alkyl (meth)acrylate, and a 2-butene-2,4-dioic acid or its derivative. The repeat units derived from alkyl (meth)acrylate can be about 50 to about 70 weight %. The repeat units derived from 2-butene-2,4-dioic acid or its derivative can be about 0.5 to about 10 weight %, about 1 to about 5 weight %, about 1.5 to about 5 weight %, about 1.5 to about 4 weight %, or about 1.5 to about 3 weight %, in which the derivative is an anhydride of the acid or a monoalkyl ester of the acid. The alkyl group in the monoalkyl ester can have 1 to about 6 carbon atoms. The repeat units derived from ethylene can comprise the remainder. The copolymer can have a number average molecular weight (Mₙ) above 20,000, above 40,000, or above 43,000, with an upper limit of about 100,000 or about 150,000; a melt index preferably from about 1 to about 30 g/10 min; and preferably a polydispersity from about 2 to about 10.

A tetrapolymer can comprise or be produced from ethylene a first alkyl (meth)acrylate, a second alkyl (meth)acrylate, and, optionally, a 2-butene-2,4-dioic acid or its derivative. The repeat units derived from the first alkyl (meth)acrylate can be about 10 to about 40 weight % or about 20 to about 30 weight %. The repeat units derived from the second alkyl (meth)acrylate can be about 15 to about 65 weight % or about 35 to about 45 weight %. The first alkyl (meth)acrylate and the second alkyl (meth)acrylate are different although they can be selected from the same group. The first alkyl (meth)acrylate and the second alkyl (meth)acrylate can each independently have 0 to 4 carbons in the alkyl group. The repeat units derived from the 2-butene-2,4-dioic acid or its derivative can be 0 to about 5 weight %, about 1 to 5 weight %, or about 2 to 5 weight %. As disclosed above, the derivative can be an anhydride of the acid or a monoalkyl ester of the acid wherein the alkyl group in the monoalkyl ester has from 1 to about 6 carbon atoms. The repeat units derived from ethylene can comprise the remainder. The copolymer can have a number average molecular weight (Mₙ) above 40,000, alternatively above 48,000, alternatively above 60,000; preferably a Mₙ with an upper limit of about 100,000 or about 150,000; a melt index (MI) preferably about 3 to about 30 g/10 minutes and a polydispersity preferably from about 2 to about 12, or from 2.5 to 10.

The ethylene elastomer or ethylene acrylic elastomer can further comprises or be produced from a curing agent, one or more additional polymers including thermosets such as epoxy resins, phenolic resins or vinyl ester resins subject to further curing or thermoplastics such as polyamides, and optionally one or more additives including filler, reinforcing fiber, fibrous structure of pulps, or combinations of two or more thereof to produce a compounded composition.

Specific examples of copolymers include ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, or combinations of two or more thereof.

Ethylene elastomer can be readily produced by copolymerizing, for example, ethylene and two alkyl (meth)acrylate(s) having from 1 to 4 carbons in the alkyl group, in the presence of a free-radical polymerization initiator including for example peroxygen compounds or azo compounds. Copolymers with acid cure sites (2-butene-2,4-dioic acid or its derivative) can be similarly produced by copolymerizing ethylene, alkyl (meth)acrylate(s) and 2-butene-2,4-dioic acid moieties, anhydrides, or monoalkyl esters thereof. The copolymerizations can be run by continuously feeding ethylene and the comonomer(s), a free radical initiator, and optionally a solvent such as methanol or the like (see e.g., U.S. Pat. No. 5,028,674) to a stirred autoclave of the type disclosed in U.S. Pat. No. 2,897,183. Alternatively, other high-pressure reactor designs with sufficient mixing, residence time, temperature and pressure control, generally known in the art as an autoclave, operated either alone or in series with or without inter-stage cooling or heating, with multiple compartments and feed zones may be employed. Reactor dimensions such as volume, length and diameter may also influence operating conditions. The rate of conversion may depend on variables such as the polymerization temperature and pressure, monomer feed temperature, the different monomers employed, concentration of the monomers in the reaction mixture, and residence time for the desired yield and copolymer composition. It may be desirable to adjust the residence time and, in some cases, to use a telogen (chain transfer/chain terminating agent) such as propane, to help adjust the molecular weight. The reaction mixture is continuously removed from the autoclave. After the reaction mixture leaves the reaction vessel, the copolymer can be separated from the unreacted monomers and solvent (if solvent is used) by, for example, vaporizing the unpolymerized materials and solvent under reduced pressure and at an elevated temperature. The copolymerization can be carried out in a pressurized reactor at elevated temperature, from 120° C. to 200° C., or from 135° C. to 170° C.; pressures of from 1800 to 3000 kg/cm², or from 2000 to 2800 kg/cm²; and feed temperatures from 30° C. to 90° C., or from 50° C. to 90° C. Appropriate peroxide initiators for the copolymerization process may depend on the reactor operating conditions, such as temperature and pressure, comonomers used, comonomer concentration, and inhibitors that are typically present in commercially available comonomers. The initiator can be employed neat as a liquid, dissolved or diluted in a suitable solvent such as odorless mineral spirits or mixed with another different initiator. Common classes of organic peroxides useful as free radical initiators include dialkyl peroxides, peroxy esters, peroxy dicarbonates, peroxy ketals, and diacyl peroxides. Examples of suitable peroxides include di(3,3,5-trimethyl hexanoyl) peroxide, tert-butyl peroxypivalate, tert-butyl peroxyneodecanoate, di(sec-butyl) peroxydicarbonate, and tert-amyl peroxyneodecanoate. These and other suitable peroxides are available under the LUPEROX® from Arkema or the TRIGONOX® from Akzo Nobel. Similarly, suitable azo initiators can be used. After the continuous operation has reached a steady state, the total per-pass conversion of monomers to polymer may vary from 5 to 25 weight %. The peroxides used are preferably those that decompose rapidly within the range of 150 to 250° C. Examples of suitable peroxides include dicumyl peroxide, 1,1-di-(t-butylperoxy)-3,3,5-trimethylcyclohexane, 2,5-bis(t-butylperoxy)-2,5-dimethyl hexane, and α,α-bis(t-butylperoxy)-diisopropylbenzene. The peroxide may be dissolved in mineral spirits. The amount of peroxide injected may vary with the acrylate types, the level of the residuals, and the twin-screw extruder processing conditions. A typical range may be from 200 ppm to 8000 ppm, alternatively from 500 ppm to 5000 ppm. Residual levels in the finished copolymer are preferably below 2500 ppm, more preferably below 1500 ppm, and even more preferably below 1000 ppm.

Depending on performance needs, an ethylene elastomer can be mixed with additional materials mostly in a form of solution in the application to provide a compounded composition that can be cured. The compositions can be mixed and cured according to the following procedure.

The functions of binder in electrode of lithium ion battery can involve adhesion to current collector and cohesion between active materials, which are known to be dependent on molecular weight of the binder. The higher the molecular weight of the binder the stronger the adhesion and the cohesion. Since trends in lithium ion battery moves toward slimmer and more flexible structures, the role of binder to accommodate functional needs becomes even more demanding. It is desirable or preferred to use multifunctional additives with an ethylene elastomer to build up its molecular weight, which can be readily achieved in existing lithium ion battery drying and annealing processes. Examples of multifunctional additives can include trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine, triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, phthalic anhydride, trimellitic anhydride, pyromellitic anhydride, benzophenone tricarboxylic anhydride, ethylene glycol bistrimellitate, glycerol tristrimellitate, methylcyclohexene dicarboxylic anhydride, alkylstyrene-maleic anhydride copolymer, polyazelaic polyanhydride, polyether amines such as JEFFAMINE® (available from Huntsman), 1, 2, 4-benzenetricarboxylic anhydride, bisphenol A, bisphenol A esters, bisphenol A diglycidyl ethers, 1,2-cyclohexanedicarboxylic anhydride, trimethylolpropane tris[poly(propylene glycol), amine terminated] ether, polyamide made from fatty dimer acid (such as VERSAMID®) and polyamines, triethylenediamine, 2,4,6-tris(dimethylaminomethyl)phenol, liquid polymercaptan, and polysulfide resin.

It is accordingly desirable to increase the molecular weight of an ethylene elastomer. A blend of the uncrosslinked copolymer and a curing agent other additives and/or polymers is subjected to a curing step at sufficient time, temperature to achieve covalent chemical bonding (i.e., crosslinking) Crosslinking involves curing the compounded composition at elevated temperature for sufficient time to crosslink the copolymer. Suitable curing can be achieved during lithium ion battery's typical drying and annealing process. For example, a crosslinked ethylene copolymer may start to be formed and cured using known procedures at about 90° C. to about 140° C. as much as 60 minutes. Additional cure/annealing heating may be conducted at about 90° C. to about 140° C. for several hours.

Such ethylene elastomers can be produced by well-known processes such as those disclosed in U.S. Pat. No. 7,521,503, U.S. Pat. No. 7,544,757, or U.S. Pat. No. 7,608,675; each if which is incorporated herein by reference. Such ethylene elastomers are commercially available as VAMAC® from DuPont.

The above disclosed ethylene elastomer, whether crosslinked or not, can be combined with a solvent system to produce a binder for LIB cathodes. Such solvent is preferred relatively polar in order to form stable solution/dispersion and/or concentrate. Examples of suitable solvents include, but are not limited to, N-methylpyrrolidone (NMP), N,N-dimethylacetamide (DMAC), N,N-diethyl acetamide, N,N-diethyl formamide, N,N-dimethylforamide (DMF), tetrahydrofuran (THF), N,N-dimethylacetoamide, acetone, methyl ethyl ketone, methyl isobutyl ketone, cyclohexanone, acetophenone, ethyl acetoacetate, 1,4-dioxane, chloroform, gamma-butyrolactone, m-cresol, monoglyme, diglyme, triglyme, tetraglyme, ethylene glycol methyl ether acetate, propylene glycol methyl ether acetate, dimethyl sulfoxide (DMSO), sulfolane, methyl acetate, ethyl acetate, propyl acetate, butyl acetate, hexyl acetate, isoamyl acetate, methoxy propanol, methoxy ethanol, methoxy methoxy ethanol, propylene carbonate, cyclohexyl acetate, 2-methoxyethyl acetate, or combinations of two or more thereof.

An ethylene elastomer can generally be dissolved or dispersed, by any means known to one skilled in the art, in one or more of the solvents illustrated above to produce a slurry composition. The amount of solvent can be adjusted such that the resulting slurry composition can have a viscosity suitable for binding the binder composite with a cathode active material, or an electroconductivity supplying agent, used for the cathode. Generally, the solvent can be present in the slurry from 50 to 90 weight %, more preferably from 70 to 90 weight %. The slurry may also comprise 1 to about 20 weight % of other binders to improve viscosity of the slurry or flexibility of an electrode. Examples of other binder can include a cellulose polymer, a polyacrylonitrile or polymethacrylonitrile, other ethylene copolymer known to one skilled in the art. The preferred weight percent of ethylene elastomer in the solution/dispersion can be from 0.01 wt % to 40 wt %, typically from 5 wt % to 15 wt %. Mechanical stirring or homogenizing is recommended to fully disperse the binder. When VAMAC® (available from DuPont) is employed, heating of binder solution is preferably at 40-100° C. Wishing not to be bound by theory, at above 100° C., undesirable side reaction of VAMAC® can or may happen, which can compromise binder performance. However, it is typical that VAMAC® is readily soluble in most of above solvents even at room temperature. A variety of VAMAC® grades are commercially available from DuPont.

The cathode active material in the slurry composition can be any one known to one skilled in the art. Suitable cathode materials for a lithium ion battery include without limitation lithiated transition metal oxides such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.2}O₂, Li_{1+z}Ni_{1-x-y}CoₓAl_{y}O₂ where 0<x<0.3, 0<y<0.1, 0<z<0.06; high voltage spinels such as LiNi_{0.5}Mn_{1.5}O₄ and those in which the Ni or Mn are partially substituted with other elements such as Fe, Ga, or Cr; lithiated transition metal phosphates such as LiFePO₄, LiMnPO₄, LiCoPO₄, LiVPO₄F; mixed metal oxides of cobalt, manganese, and nickel such as those described in U.S. Pat. No. 6,964,828 and U.S. Pat. No. 7,078,128; nanocomposite cathode compositions such as those described in U.S. Pat. No. 6,680,145; lithium-rich layered-layered composite cathodes such as those described in U.S. Pat. No. 7,468,223; and cathodes such as those described in U.S. Pat. No. 7,718,319 and the references therein. Other non-lithium metal compounds can include transition metal sulfides such as TiS₂, TiS₃, MoS₃ and transition metal oxides such as MnO₂, Cu₂V₂O₃, amorphous V₂OP₂O₅, MoO₃, V₂O₅, and V₆O₁₃.

The anode active material in the slurry composition can be any one known to one skilled in the art. Anode active materials can include without limitation carbon materials such as carbon, activated carbon, graphite, natural graphite, mesophase carbon microbeads; lithium alloys and materials which alloy with lithium such as lithium-aluminum alloys, lithium-lead alloys, lithium-silicon alloy, lithium-tin alloy, lithium-antimony alloy and the like; carbon materials such as graphite and mesocarbon microbeads (MCMB); metal oxides such as SnO₂, SnO and TiO₂; and lithium titanates such as Li₄Ti₅O₁₂ and LiTi₂O₄. In one embodiment, the anode active material is lithium titanate or graphite.

Electrically conductive aids may be also added to the slurry to reduce the resistance and increase the capacity of the resulting electrode. Suitable conductive aids include without limitation acetylene black, or furnace black, and carbon fibers and nanotubes.

A cathode active material or the anode active material can be combined with the slurry by any means known to one skilled in the art. The cathode active material or anode active material can be present in the binder composite from 0.1 to 30, 0.5 to 20, or 1 to 10 weight % of the total final composition.

The slurry composition comprising the ethylene elastomer and solvent or the electrode composition comprising the slurry composition and the cathode active material (or anode active material) can be mixed by any means known to one skilled in the art such as, for example, using a ball mill, sand mill, an ultrasonic disperser, a homogenizer, or a planetary mixer.

Any current collector known to one skilled in the art can be used. For example, metals such as iron, copper, aluminum, nickel, and stainless steel can be used. A slurry composition containing the cathode active material or the anode active material disclosed above can be applied or combined onto a current collector followed by drying the slurry and bonding the resultant electrode layer comprising the binder cathode active material or anode active material. Drying can be carried out by any means known to one skilled in the art such as drying with warm or hot air, vacuum drying, infrared drying, or dried with electron beams. The final dry binder layer can be in the range of about 0.0001 to about 6 mm, 0.005 to 5 mm, or 0.01 to 3 mm. Applying a slurry onto a current collector can be carried out by any means known to one skilled in the art such as, for example, using doctor blade, dipping, reverse roll, direct roll, gravure, or brush-painting.

A battery or lithium ion battery can be produced by any means known to one skilled in the art the means thereof is omitted herein for the interest of brevity. An electrolyte may be in a gel or liquid form if the electrolyte is an electrolyte that can be used in a lithium ion battery. The electrolyte typically comprises a lithium salt dissolved in solvent. Known salts include LiClO₄, LiBF₄, LiPF₆, LiCF₃CO₂, LiB(C₂O₄)₂, LiN(SO₂CF₃)₂LiAsF₆, or LiSbF₆. Solvents may comprise compounds such as propylene carbonate, ethylene carbonate, butylene carbonate, dimethyl carbonate, ethyl methyl carbonate, and diethyl carbonate, trimethoxymethane, diethyl ether, 2-ethoxyethane, tetrahydrofuran, 2-methyltetrahydrofuran, or combinations of two or more thereof.

### EXAMPLES

### Example 1

### Generation of VAMAC®GLS Solution in Ethyl Acetoacetate Solvent

VAMAC® GLS obtained from DuPont was dried in a vacuum oven at 50° C. and below 10 mmHg for 18 hours and cooled down under a nitrogen atmosphere. 10 g of dried VAMAC® GLS was placed in a 500 ml three-necked round bottomed flask equipped with a condenser, nitrogen tee, a thermometer and mechanical stirrer. 90 g of ethyl acetoacetate was added, which were used as purchased from Aldrich. The mixture was slowly stirred by the mechanical stirring. The temperature of the mixture was increased to 50° C. As the resin started to soften, stirring could be intensified appropriately. Stirring was continued for 3 hours after the temperature of the mixture reached 50° C. Completely dispersed VAMAC® GLS in solvent-ethyl acetoacetate was transferred to a glass container with a cap and was allowed to cool down at ambient temperature. Upon cool down, the dispersion formed a honey-like dense solution that was flowed easily.

### Example 2

### Fabrication of Cathode of Secondary Battery and Assembly of Coin Cell of Secondary Battery

All parts disclosed here are by weight. Five (5) parts of carbon (Super C65, Timcal, Westlake, Ohio) and 4 parts of VAMAC® GLS with 100 ppm of hexamethylene diamine in a form 10 weight % solution made by the method of example 1 were combined in a vial and mixed using a planetary centrifugal mixer (ARE-310, Thinky USA, Inc., Laguna Hills, Calif.) at 2000 rpm for 2 minutes. Ninety (90) parts of lithium nickel manganese cobalt oxide (NM-1101, Toda America, Battle Creek, Mich.) and additional amount of solvents were added and the slurry again centrifugally mixed at 1000 rpm for 2 minutes. The mixture was further homogenized twice using a rotor-stator (model PT 10-35 GT, 7.5 mm dia. stator, Kinematicia, Bohemia, N.Y.) for 1 minute at 6000 rpm and then for 5 minutes at 9500 rpm. If the temperature of vial increased to become hot, the vial was alternatively placed in an ice bath during homogenization. Finally the slurry was centrifugally mixed again at 1000 rpm for 2 min. Using a doctor coater, the slurry was uniformly applied on the surface of lithium ion battery grade A1 foil (1 mil=25.4 micron thickness) that was pre-cleaned by isopropyl alcohol and dichloromethane and gently scratched to facilitate adhesion. The slurry (i.e., dispersion of cathode active material, carbon black, and binder in a solvent) coated cathode was dried in a convection oven (model FDL-115, Binder Inc., Great River, N.Y.) for an hour under ramping temperature from 30° C. to 100° C. The resulting 51-mm wide cathode was placed between 125 μm thick brass sheets and passed through a calender three times using 100 mm diameter steel rolls at ambient temperature with nip forces increasing in each of the passes, starting at 154 kg with the final pass at 257 kg. The thickness of calendared cathode was about 3 mils. Cathode disks were punched out by using a ½-inch diameter arch punch, and were further dried overnight in a dry-box antechamber under vacuum at 90° C. After 18 hours, inside an Ar (argon) dry box, nonaqueous electrolyte lithium-ion CR2032 coin cells were prepared for electrochemical evaluation. The coin cell parts (case, spacer, wave spring, gasket, and lid) and coin cell crimper were obtained from Hohsen Corp (Osaka, Japan). The anodes were lithium metal (275 μm thick, Chemetall Foote, Kings Mountain, N.C.) and the separator was a microporous polyolefin (CG2325, Celgard, LLC. Charlotte, N.C.). The electrolyte was ethyl methyl carbonate (70 v %)/ethylene carbonate (30 v %)/1 M LiPF₆ (Novolyte Purolyte A2 Series, BASF, Independence, Ohio). The cells were cycled using a commercial battery tester (Series 4000, Maccor, Tulsa, Okla.) at ambient temperature using constant current charging and discharging between voltage limits of 3.0-4.25 V at a current of 35 mA per gram of cathode active material (˜0.25 C).

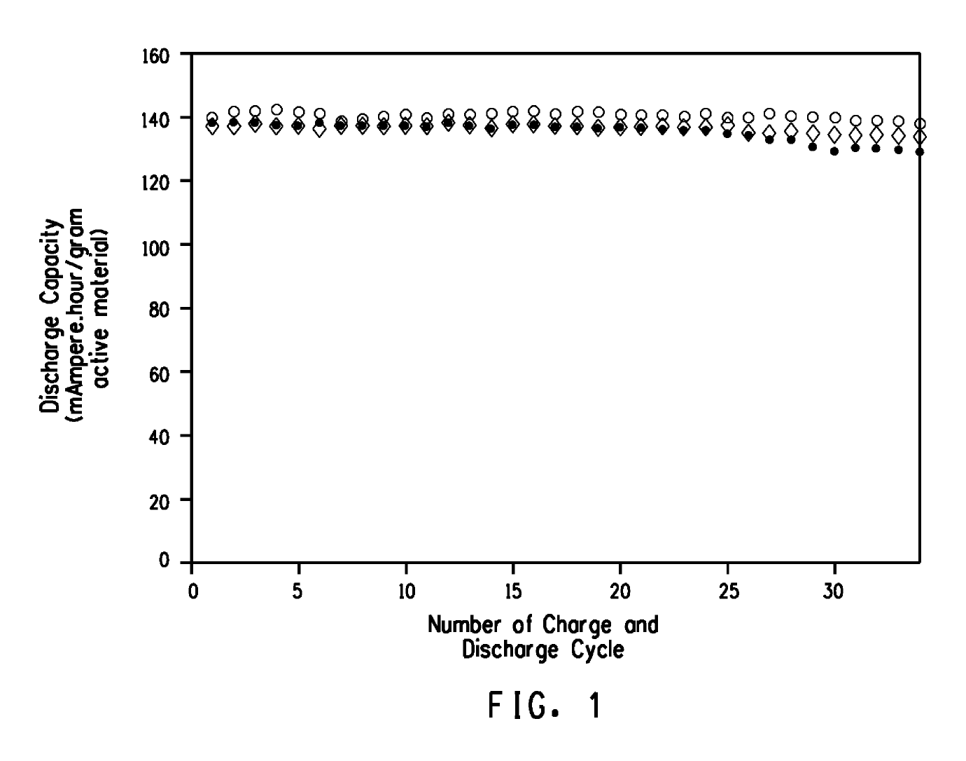

FIG. 1 shows two different coin cells made from cathode active material of NMC (lithium nickel manganese cobalt oxide (LiNi0.333Mn0.333Co0.333O2)) and carbon black (Super C65, Timcal, Westlake, Ohio) by above described methods provided capacity of about 135 mAh/g under 4.25 V charge, 3 V discharge and 0.25 C-rate. The open circles represent coin cells #1 and the open triangles represent coin cell #2; both coin cells were made with VAMAC® as binder, and the closed circles represent coin cell #3 made with PVDF as binder. Under same test conditions, the coin cells made with VAMAC® showed almost same discharge capacities and charge/discharge performances as that made with PVDF.

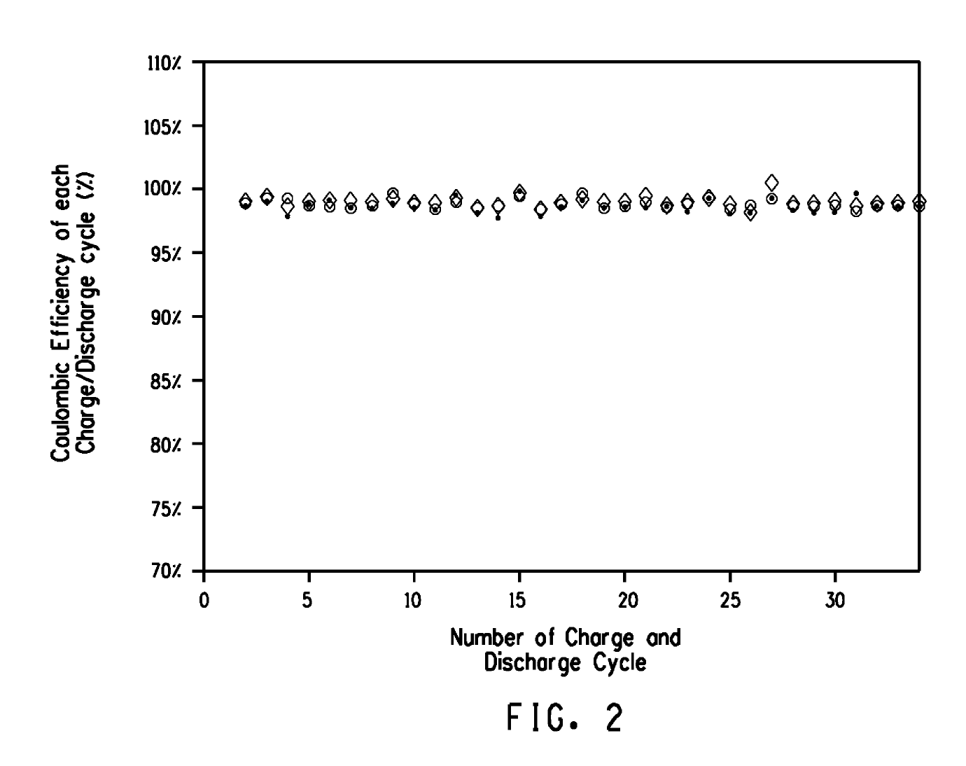

In FIG. 2, similar to FIG. 1, performance of two different coin cells were shown. The open diamonds represent coin cell #1 and the closed triangles represent coin cell #2; again, both were made from NMC, carbon black, and VAMAC® as binder. The closed circles represent coin cell made from NMC, carbon black, and PVDF as binder. Under same test conditions, the coin cell made with VAMAC® showed almost same Coulombic efficiency (CE) as that made with PVD in each cycle which is defined as discharge capacity/charge capacity. CE was about 80% in the first cycle and above about 97% in subsequent cycles.

1. A binder composition comprising or produced from an ethylene elastomer and a solvent wherein
the composition is a binder for a lithium ion battery;
the elastomer comprises or is produced from repeat units derived from ethylene and one or more comonomer, which is an alky(meth)acrylate; and
the elastomer optionally comprises a curing agent.

2. The composition of claim 1 wherein the elastomer further comprises or is further produced from repeat units derived from 2-butene-1,4-dioic acid or its derivative and the elastomer optionally further comprises or is further produced from repeat units derived from a second alky (meth)acrylate.

3. The composition of claim 2 wherein the derivative is an anhydride of the acid or a monoalkyl ester of the acid; and the alkyl group in the monoalkyl ester has 1 to about 6 carbon atoms.

4. The composition of claim 3 wherein the elastomer further comprises or is further produced from repeat units derived from the second alky (meth)acrylate.

5. The composition of claim 3 wherein the derivative is an anhydride of the acid or a monoalkyl ester of the acid; and the alkyl group in the monoalkyl ester has 1 to about 6 carbon atoms.

6. The composition of claim 5 wherein the elastomer is ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, or combinations of two or more thereof.

7. The composition of claim 6 wherein
the elastomer further comprises or is further produced from a curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, alkylstyrene-maleic anhydride copolymer, polyazelaic polyanhydride, polyether amines, 1, 2, 4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, or combinations of two or more thereof; and
the solvent is N-methylpyrrolidone, N,N-dimethylacetamide, N,N-diethylacetamide, N,N-diethyl formamide, N,N-dimethylforamide, tetrahydrofuran, acetone, methyl ethyl ketone, methyl isobutyl ketone, cyclohexanone, acetophenone, ethyl acetoacetate, 1,4-dioxane, chloroform, gamma-butyrolactone, m-cresol, monoglyme, diglyme, triglyme, tetraglyme, ethylene glycol methyl ether acetate, propylene glycol methyl ether acetate, dimethyl sulfoxide, sulfolane, methyl acetate, ethyl acetate, propyl acetate, butyl acetate, hexyl acetate, isoamyl acetate, methoxy propanol, methoxy ethanol, propylene carbonate, cyclohexyl acetate, 2-methoxyethyl acetate, or combinations of two or more thereof.

8. The composition of claim 7 wherein the elastomer is crosslinked.

9. A lithium ion battery electrode comprising a binder composition and a cathode active material wherein
the binder composition is as characterized in claim 1; and
the cathode active material comprises a lithiated transition metal oxide or lithiated transition metal phosphate, or combinations thereof.

10. The lithium ion battery electrode of claim 9 wherein
the elastomer further comprises or is further produced from repeat units derived from 2-butene-1,4-dioic acid or its derivative;
the elastomer further comprises or is further produced from repeat units derived from a second alky (meth)acrylate; and
the derivative is an anhydride of the acid or a monoalkyl ester of the acid; and the alkyl group in the monoalkyl ester has 1 to about 6 carbon atoms.

11. The lithium ion battery electrode of claim 10 wherein the derivative is an anhydride of the acid or a monoalkyl ester of the acid; and the alkyl group in the monoalkyl ester has 1 to about 6 carbon atoms.

12. The lithium ion battery electrode of claim 11 wherein the elastomer is ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, or combinations of two or more thereof.

13. The lithium ion battery electrode of claim 12 wherein
the elastomer further comprises or is further produced from a curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, methylcyclohexene dicarboxylic anhydride, alkylstyrene-maleic anhydride copolymer, polyazelaic polyanhydride, polyether amines, 1, 2, 4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, or combinations of two or more thereof; and
the solvent is N-methylpyrrolidone, N,N-dimethylacetamide, N,N-diethylacetamide, N,N-diethyl formamide, N,N-dimethylforamide, tetrahydrofuran, acetone, methyl ethyl ketone, methyl isobutyl ketone, cyclohexanone, acetophenone, ethyl acetoacetate, 1,4-dioxane, chloroform, gamma-butyrolactone, m-cresol, monoglyme, diglyme, triglyme, tetraglyme, ethylene glycol methyl ether acetate, propylene glycol methyl ether acetate, dimethyl sulfoxide, sulfolane, methyl acetate, ethyl acetate, propyl acetate, butyl acetate, hexyl acetate, isoamyl acetate, methoxy propanol, methoxy ethanol, propylene carbonate, cyclohexyl acetate, 2-methoxyethyl acetate, or combinations of two or more thereof.

14. The lithium ion battery electrode of claim 13 wherein the elastomer is crosslinked.

15. A lithium ion battery electrode comprising a binder composition and an anode active material wherein
the binder composition is as characterized in claim 2; and
the anode active material comprises a carbon, lithium titanate, Si, Sn, Sb, or alloys or precursors to lithium alloys with Si, Sn, or Sb.

16. The lithium ion battery electrode of claim 15 wherein
the elastomer further comprises or is further produced from repeat units derived from 2-butene-1,4-dioic acid or its derivative;
the elastomer further comprises or is further produced from repeat units derived from a second alky (meth)acrylate; and
the derivative is an anhydride of the acid or a monoalkyl ester of the acid; and the alkyl group in the monoalkyl ester has 1 to about 6 carbon atoms.

17. The lithium ion battery electrode of claim 16 wherein the derivative is an anhydride of the acid or a monoalkyl ester of the acid; and the alkyl group in the monoalkyl ester has 1 to about 6 carbon atoms.

18. The lithium ion battery electrode of claim 17 wherein the elastomer is ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, or combinations of two or more thereof.

19. The lithium ion battery electrode of claim 18 wherein
the elastomer further comprises or is further produced from a curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, alkylstyrene-maleic anhydride copolymer, polyazelaic polyanhydride, polyether amines, 1, 2, 4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, or combinations of two or more thereof; and
the solvent is N-methylpyrrolidone, N,N-dimethylacetamide, N,N-diethylacetamide, N,N-diethyl formamide, N,N-dimethylforamide, tetrahydrofuran, acetone, methyl ethyl ketone, methyl isobutyl ketone, cyclohexanone, acetophenone, ethyl acetoacetate, 1,4-dioxane, chloroform, gamma-butyrolactone, m-cresol, monoglyme, diglyme, triglyme, tetraglyme, ethylene glycol methyl ether acetate, propylene glycol methyl ether acetate, dimethyl sulfoxide, sulfolane, methyl acetate, ethyl acetate, propyl acetate, butyl acetate, hexyl acetate, isoamyl acetate, methoxy propanol, methoxy ethanol, propylene carbonate, cyclohexyl acetate, 2-methoxyethyl acetate, or combinations of two or more thereof.

20. The lithium ion battery electrode of claim 19 wherein the elastomer is crosslinked.
